(19) United States
(12) Patent Application Publication
(10) Pub. No.: US 2025/0321524 A1
(43) Pub. Date: Oct. 16, 2025

(54) IMAGE FORMING APPARATUS AND INFORMATION PROCESSING DEVICE

(71) Applicant: CANON KABUSHIKI KAISHA, Tokyo (JP)

(72) Inventors: KYOHEI KIKUCHI, Ibaraki (JP); TOSHIYUKI YAMADA, Tokyo (JP); MASAMI HANO, Chiba (JP); KOTA MORI, Chiba (JP); ATSUSHI MATSUMOTO, Ibaraki (JP); MARIKO SAKAMOTO, Chiba (JP)

(21) Appl. No.: 19/176,781

(22) Filed: Apr. 11, 2025

(30) Foreign Application Priority Data
Apr. 12, 2024 (JP) 2024-064419

(51) Int. Cl. G03G 15/00; G03G 15/23; H04N 1/23

(52) U.S. Cl. CPC G03G 15/502; G03G 15/234; H04N 1/2369

(57) ABSTRACT

An image forming apparatus includes a selector configured to select a first mode for forming an image on a first recording material including a first side which is closed, a second side which is closed, a third side which is open, and a fourth side which is open, a tray on which the first recording material is to be placed, an image former configured to form an image on the first recording material conveyed from the tray, a display, and a controller configured to control, in a case where the first mode is selected by the selector, an orientation of an image to be formed in accordance with an orientation in which the first recording material is placed on the tray.

### BACKGROUND OF THE INVENTION

### Field of the Invention

The present disclosure relates to an image forming apparatus which forms an image on a recording material by using an electrophotographic method or an electrostatic recording method.

### Description of the Related Art

An image forming apparatus generally prints images using paper, for example, defined in the Japanese Industrial Standards as a recording material. The image forming apparatus can use various sizes and types of paper or a document folder as the recording material. In Japanese Patent Application Laid-open No. 2011-168394, an image forming apparatus which conveys a document folder is disclosed.

A document folder has a shape in which at least one side is closed and at least one side is open. In a case where an image is formed on a recording material having such a shape, there is a possibility that the orientation in which the recording material is placed and the orientation in which the image is formed do not match.

### SUMMARY OF THE INVENTION

An image forming apparatus according to some embodiments of the present disclosure includes a selector configured to select a first mode for forming an image on a first recording material including a first side which is closed, a second side which is closed, a third side which is open, and a fourth side which is open, a tray on which the first recording material is to be placed, an image former configured to form an image on the first recording material conveyed from the tray, a display, and a controller configured to control, in a case where the first mode is selected by the selector, an orientation of an image to be formed in accordance with an orientation in which the first recording material is placed on the tray.

An image forming apparatus according to another embodiment of the present disclosure includes a selector configured to select a first mode for forming an image on a first recording material including a first side which is closed, a second side which is closed, a third side which is open, and a fourth side which is open, a tray on which the first recording material is to be placed, an image former configured to form an image on the first recording material conveyed from the tray, a display, and a controller configured to perform, in a case where the first mode is selected by the selector and duplex printing is performed, conversion processing of reversing an orientation of a first image to be formed on a first surface of the first recording material or an orientation of a second image to be formed on a second surface of the first recording material opposite to the first surface, wherein the first image and the second image are formed to have reverse orientations in a width direction orthogonal to a conveyance direction on an image forming surface of a recording material.

An information processing device which is communicably connected to an image forming apparatus yet another embodiment of the present disclosure includes a tray on which a first recording material is to be placed, the first recording material including a first side which is closed, a second side which is closed, a third side which is open, and a fourth side which is open; and an image former configured to form an image on the first recording material conveyed from the tray, the information processing device including a selector configured to select a first mode for forming an image on the first recording material, a display, and a controller configured to control, in a case where the first mode is selected by the selector, an orientation of an image to be formed in accordance with an orientation in which the first recording material is placed on the tray.

An information processing device which is communicably connected to an image forming apparatus according to yet another embodiment of the present disclosure includes a tray on which a first recording material is to be placed, the first recording material including a first side which is closed, a second side which is closed, a third side which is open, and a fourth side which is open; and an image former configured to form an image on the first recording material conveyed from the tray, the information processing device including a selector configured to select a first mode for forming an image on the first recording material, a display, and a controller configured to perform, in a case where the first mode is selected by the selector and duplex printing is performed, conversion processing of reversing an orientation of a first image to be formed on a first surface of the first recording material or an orientation of a second image to be formed on a second surface of the first recording material opposite to the first surface in a width direction orthogonal to a conveyance direction on an image forming surface of a recording material.

Further features of the present invention will become apparent from the following description of exemplary embodiments (with reference to the attached drawings).

### BRIEF DESCRIPTION OF THE DRAWINGS

FIG. 1 is a configuration view of an image forming system.

FIG. 2 is an explanatory diagram of a main controller.

FIG. 3 is a configuration explanatory view of an operation unit.

FIG. 4 is a configuration view of an image forming apparatus.

FIG. 5 is an exemplary view of a sheet type selection screen.

FIG. 6 is a flowchart for illustrating image forming processing.

FIG. 7 is an exemplary view of a duplex printing selection screen.

FIG. 8A and FIG. 8B are exemplary views of a guide screen.

FIG. 9 is an exemplary view of an instruction screen.

FIG. 10A, FIG. 10B, FIG. 10C, and FIG. 10D are explanatory diagrams of placement states of a document folder.

FIG. 11 is an exemplary view of an input screen of the placement state of a recording material.

FIG. 12A, FIG. 12B, FIG. 12C, and FIG. 12D are explanatory diagrams of reversal of an image.

FIG. 13 is an exemplary view of a setting screen for setting whether or not conversion processing of an image signal is enabled.

FIG. 14 is an exemplary view of a duplex printing selection screen.

FIG. 15 is a flowchart for illustrating image forming processing.

FIG. 16 is an exemplary view of a selection screen for selecting which surface of a recording material an image is to be printed on.

### DESCRIPTION OF THE EMBODIMENTS

Now, referring to the accompanying drawings, description is given of at least one exemplary embodiment of the present disclosure. In the at least one embodiment, description of an electrophotographic image forming apparatus is given as an example, but the present disclosure is effective even for other types of image forming apparatus, such as an inkjet type apparatus.

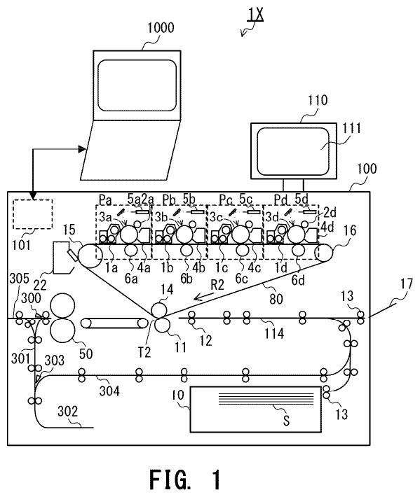

FIG. 1 is a configuration view of an image forming system including an image forming apparatus according to the at least one embodiment. An image forming system 1X includes an image forming apparatus 100 which forms a toner image on a recording material S, and an operation unit 110 which has a display 111. The image forming apparatus 100 according to the at least one embodiment is an electrophotographic tandem full-color printer. The image forming apparatus 100 may be configured to form images using an electrostatic recording method. The image forming apparatus 100 includes, as an image former, an image forming unit Pa for forming a yellow image, an image forming unit Pb for forming a magenta image, an image forming unit Pc for forming a cyan image, and an image forming unit Pd for forming a black image.

The image forming apparatus 100 forms a toner image on the recording material S based on data relating to the toner image included in image data, which is acquired from an external device 1000 such as an original reading apparatus (not shown) or a personal computer communicably connected to the image forming apparatus 100, for example. Examples of materials that can be used as the recording material S include a sheet material made of paper, such as general plain paper, cardboard, rough paper, textured paper, and coated paper, as well as, in the at least one embodiment, a document folder having a bag shape formed from a sheet material made of plastic.

Description is now given of a conveyance process of the recording material S. The recording material S is accommodated and placed in a cassette 10, or is placed on a tray 17. The recording material S is fed from the cassette 10 or the tray 17 by feed rollers 13 in accordance with the image forming timing. The tray 17 is provided so as to be openable and closable by a user, for example. The recording material S fed by the feed rollers 13 is conveyed to registration rollers 12 arranged along a conveyance path 114. The registration rollers 12 perform skew correction and timing correction, and then convey the recording material S to a secondary transfer unit T2. The secondary transfer unit T2 is a transfer nip unit formed by an inner secondary transfer roller 14 and an outer secondary transfer roller 11. The secondary transfer unit T2 transfers the toner image onto the recording material S by applying a secondary transfer voltage to the outer secondary transfer roller 11.

Description is now given of the image forming process in which the toner image is conveyed to the secondary transfer unit T2 at the same timing relative to the process of conveying the recording material S to the secondary transfer unit T2. Description is given of the configuration of the image forming units Pa, Pb, Pc, and Pd. The image forming units Pa, Pb, Pc, and Pd have substantially the same configuration, except that the colors of the images (toner images) to be formed are different among yellow, magenta, cyan, and black. Here, description is given of the image forming unit Pd which forms a black toner image, and description of the other image forming units Pa, Pb, and Pc is omitted.

The image forming unit Pd mainly includes a developing device 1d, a charging device 2d, a photosensitive drum 3d, a photosensitive drum cleaner 4d, an exposure device 5d, a primary transfer roller 6d, and the like. The photosensitive drum 3d is a photosensitive member having a photosensitive layer on a surface, and is rotated around a drum shaft. The charging device 2d uniformly charges the surface of the photosensitive drum 3d being rotated. The exposure device 5d forms an electrostatic latent image by irradiating the charged surface of the photosensitive drum 3d with a laser beam which is driven based on an image signal. The developing device 1d forms a black toner image on the surface of the photosensitive drum 3d by using a developer to develop the electrostatic latent image formed on the photosensitive drum 3d.

The primary transfer roller 6d is provided so as to sandwich an intermediate transfer belt 80 at a position opposing the photosensitive drum 3d. The primary transfer roller 6d transfers the toner image formed on the photosensitive drum 3d onto the intermediate transfer belt 80 by applying a primary transfer voltage. Transfer residual toner remaining on the photosensitive drum 3d after the transfer is collected by the photosensitive drum cleaner 4d.

In the same manner, a yellow toner image is formed on a photosensitive drum 3a of the image forming unit Pa, and the toner image is transferred onto the intermediate transfer belt 80 by a primary transfer roller 6a. A magenta toner image is formed on a photosensitive drum 3b of the image forming unit Pb, and the toner image is transferred onto the intermediate transfer belt 80 by a primary transfer roller 6b. A cyan toner image is formed on a photosensitive drum 3c of the image forming unit Pc, and the toner image is transferred onto the intermediate transfer belt 80 by a primary transfer roller 6c.

The intermediate transfer belt 80 is an endless belt stretched around the inner secondary transfer roller 14 and tensioning rollers 15 and 16, and is driven in the direction of an arrow R2. In the at least one embodiment, the tensioning roller 16 also serves as a drive roller which drives the intermediate transfer belt 80. The image forming process of each of the image forming units Pa to Pd is performed at a timing such that the transferred toner images of the respective colors are sequentially superimposed on the intermediate transfer belt 80. As a result, in the end, a full-color toner image is formed on the intermediate transfer belt 80.

The intermediate transfer belt 80 conveys the toner image to the secondary transfer unit T2 by rotating. Conveyance of the toner image to the secondary transfer unit T2 is performed in accordance with the timing at which the recording material S is conveyed to the secondary transfer unit T2. As a result, the toner image is transferred onto a predetermined position on the recording material S. Transfer residual toner remaining on the intermediate transfer belt 80 after the transfer by the secondary transfer unit T2 is removed by a transfer cleaner 22.

The toner image is borne on the recording material S by a conveyance process and an image forming process such as those described above. The recording material S is conveyed from the secondary transfer unit T2 to a fixing device 50. The fixing device 50 fixes the toner image on the recording material S by applying heat and pressure to the recording material S bearing the toner image. For this purpose, the fixing device 50 has a first roller that includes a built-in heat source and a second roller that is biased toward the first roller, and conveys the recording material S by sandwiching the recording material S between the first roller and the second roller. At this time, the recording material S is heated by the heat source and pressed by the second roller. As a result, each toner image borne by the recording material S is melted and mixed, and is fixed on the recording material S as a full-color image.

The recording material S on which the image has been fixed is guided by a flapper 300 to any one of a conveyance path 301 and a conveyance path 305. The flapper 300 guides the recording material S to the conveyance path 305 in a case where the printing surface (image forming surface) is not reversed in simplex printing and in a case where printing on both surfaces is finished in duplex printing. The recording material S guided to the conveyance path 305 is delivered to outside the image forming apparatus 100.

The flapper 300 guides the recording material S to the conveyance path 301 in a case where printing on the front surface (first surface) is finished in duplex printing and in a case where the printing surface is reversed in simplex printing. The recording material S is conveyed to a reversing unit 302 via the conveyance path 301. The conveyance direction of the recording material S conveyed to the reversing unit 302 is reversed, and the recording material S is guided by a flapper 303 to any one of the conveyance path 301 and a duplex-printing conveyance path 304. Through reversing the conveyance direction by the reversing unit 302 and conveying the recording material S to the conveyance path 301 or the duplex-printing conveyance path 304, the printing surface of the recording material S is reversed.

The flapper 303 guides the recording material S to the conveyance path 301 when reversing the printing surface in simplex printing. The recording material S guided to the conveyance path 301 is delivered from the conveyance path 301 to outside the image forming apparatus 100 via the conveyance path 305. The flapper 303 guides the recording material S to the duplex-printing conveyance path 304 in a case where duplex printing on the front surface is finished. The recording material S guided to the duplex-printing conveyance path 304 is conveyed to the secondary transfer unit T2. As a result, an image is printed on the back surface (second surface) of the recording material S.

The developer to be used in the at least one embodiment is a two-component developer containing a toner and a carrier. The toner contains a binder resin, a colorant, and a release agent (wax). A publicly-known binder resin may be used as the binder resin. For example, a vinyl-based copolymer typified by a styrene-(meth)acrylic copolymer, a polyester resin, a hybrid resin in which a vinyl-based copolymer unit and a polyester unit are chemically bonded to each other, an epoxy resin, or a styrene-butadiene copolymer may be used as the binder resin. A publicly-known colorant may be used as a colorant for each of the colors of yellow, magenta, cyan, and black.

For example, an aliphatic hydrocarbon-based wax or an oxide of an aliphatic hydrocarbon-based wax, or a block copolymerized product thereof may be used as the release agent. The aliphatic hydrocarbon-based wax is, for example, low-molecular-weight polyethylene, a low-molecular-weight olefin copolymer wax, a microcrystalline wax, a Fischer-Tropsch wax, or a paraffin wax. The oxide of the aliphatic hydrocarbon-based wax is, for example, a polyethylene oxide wax. The block copolymerized product is a wax containing a fatty acid ester as a main component, an ester wax, or a product obtained by deacidifying part or whole of a fatty acid ester such as deacidified carnauba wax. Examples of the wax containing a fatty acid ester as a main component include a carnauba wax and a montanoic acid ester wax. The ester wax is, for example, a synthesis reaction product of a higher fatty acid and a higher alcohol, such as behenyl behenate or behenyl stearate.

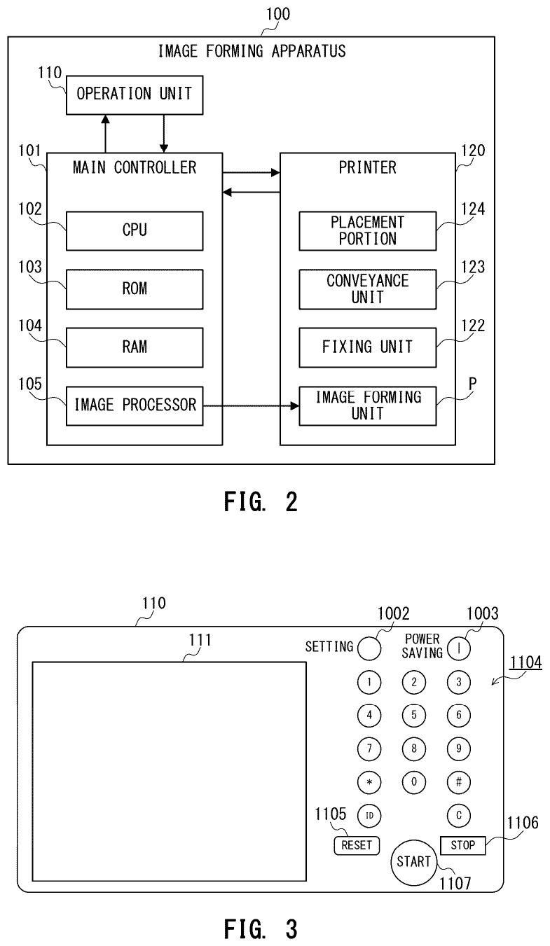

Operation of such an image forming apparatus 100 is controlled by a main controller 101. FIG. 2 is an explanatory diagram of the main controller 101. The main controller 101 can communicate to and from a printer 120 and the operation unit 110. The printer 120 includes various units used in, for example, the conveyance process and the image forming process described above.

The main controller 101 includes a central processing unit (CPU) 102, a read-only memory (ROM) 103, a random-access memory (RAM) 104, and an image processor 105. The CPU 102 controls the overall operation of the image forming system 1X by executing computer programs stored in the ROM 103. The RAM 104 provides a work area in a case where the CPU 102 executes processing. The image processor 105 transmits, to the image forming units Pa to Pd, an image signal generated by performing predetermined image processing on image data acquired from the external device 1000, such as converting the image data into a format that can be processed by exposure devices 5a to 5d of the image forming units Pa to Pd.

The printer 120 includes a placement portion 124, a conveyance unit 123, a fixing unit 122, and an image forming unit P. The image forming unit P represents the above-mentioned image forming units Pa to Pd. The placement portion 124 is the cassette 10 and the tray 17, and the recording material S is accommodated or placed therein. The conveyance unit 123 feeds the recording material S from the placement portion 124, conveys the recording material S to the secondary transfer unit T2 and the fixing device 50, and delivers the recording material S to outside the image forming system 1X. The conveyance unit 123 includes the feed rollers 13 and the registration rollers 12. The fixing unit 122 is the above-mentioned fixing device 50, and fixes the toner image on the recording material S. The image forming unit P includes the image forming units Pa to Pd which form the toner images of the respective colors as described above. The image forming unit P controls the drive of the laser beams output from the exposure devices 5a to 5d based on the image signal acquired from the image processor 105.

In order to perform optimal print settings, the image forming apparatus 100 according to the at least one embodiment is required to set the sheet type based on an instruction from the user by using the operation unit 110. The operation unit 110 is a user interface having the display 111 being an input interface and an output interface. The operation unit 110 is used, for example, to acquire the sheet type setting of the recording material S used for image formation. FIG. 3 is a configuration explanatory view of the operation unit 110.

The operation unit 110 in the at least one embodiment has, as input interfaces, a setting key 1002, a power saving key 1003, a hard key group 1104, a reset key 1105, a stop key 1106, and a start key 1107. Further, the operation unit 110 may include a touch panel provided on the display 111 as an input interface. Content (for example, information required for creating job information such as the type of the recording material S, the number of print copies, and output attribute information) input by using the input interfaces is transmitted to the CPU 102. The user can input information by using the input interfaces.

The setting key 1002 is pressed in a case where various settings such as the sheet type setting are performed. The power saving key 1003 is pressed in a case where the image forming apparatus 100 is set to a sleep mode or the image forming apparatus 100 is woken up from the sleep mode. The image forming apparatus 100 transitions to the sleep mode in a case where the power saving key 1003 is pressed in a normal mode, and transitions to the normal mode in a case where the power saving key 1003 is pressed in the sleep mode. The hard key group 1104 includes a numeric keypad, a clear key, and an authentication key. The reset key 1105 is pressed in a case where various settings are reset. The stop key 1106 is pressed in a case where an operation in progress is stopped. The start key 1107 is pressed in a case where a printing operation is started or in a case where another function is instructed to start. The start key 1107 includes two-color light emitting diodes (LEDs), which are green and red LEDs (not shown). In a case where the start key 1107 is lit in green, this indicates that it is possible to start, and in a case where the start key 1107 is lit in red, this indicates that it is not possible to start.

The various keys described above are hardware keys, but those various keys may be implemented by software keys displayed on the display 111. Further, the various keys may be implemented by combining hardware keys and software keys.

### Examples of Other Image Forming Apparatus

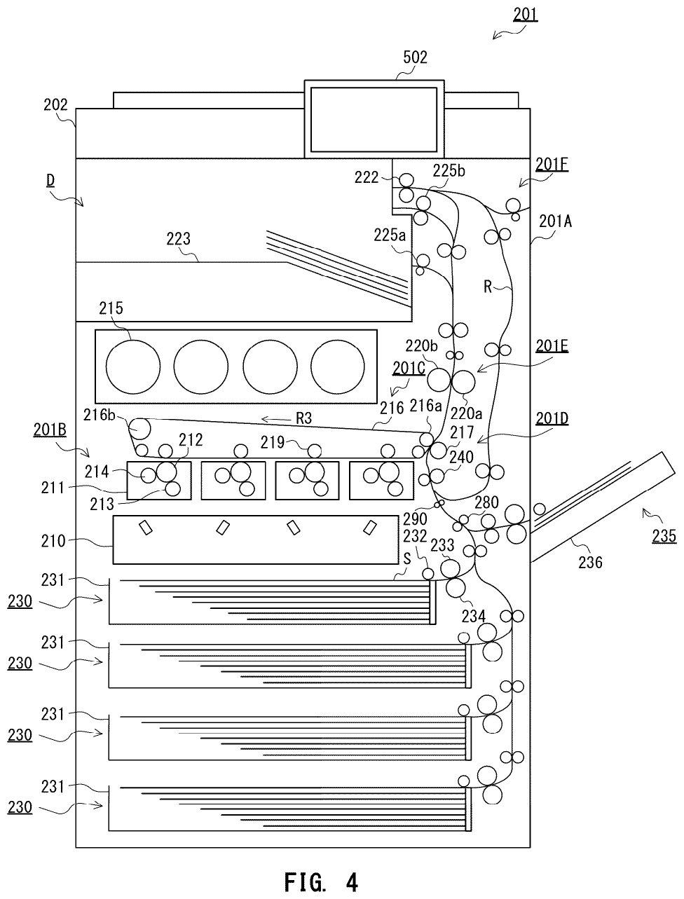

The image forming apparatus 100 described with reference to FIG. 1 prints an image while conveying the recording material S in a horizontal direction parallel to the lower surface of the image forming apparatus 100. That is, the conveyance path 114 along which the recording material S is conveyed is a horizontal path extending in the horizontal direction. Among image forming apparatus, there are image forming apparatus which print images while conveying the recording material S in a perpendicular direction (vertical direction) orthogonal to the lower surface of the image forming apparatus (vertical path). FIG. 4 is a configuration view of such an image forming apparatus. An image forming apparatus 201 is a laser beam printer of a tandem intermediate-transfer type using an electrophotographic process. The image forming apparatus 201 forms a full-color image or a monochrome image on a recording material S being a recording medium and outputs the recording material S based on image data acquired from an external device 1000 (see FIG. 1) via a network or based on image data acquired from an image reading device 202 which is provided on the top of the image forming apparatus 201.

The image forming apparatus 201 has, inside a main body 201A, components for forming an image, and includes, on the top of the main body 201A, the image reading device 202 and an operation unit 502 having the same configuration as the operation unit 110 of FIG. 1. A delivery space D including a placement portion 223 for receiving the recording material S to be delivered thereinto after image formation is defined between the main body 201A of the image forming apparatus 201 and the image reading device 202.

The image reading device 202 is a scanner which reads an image from an original to generate image data. The image reading device 202 is used, for example, at the time of processing of copying an original. The image reading device 202 in the at least one embodiment is configured as a part of the image forming apparatus 201. The image reading device 202 is not limited to this configuration, and the image reading device 202 may be configured to be electrically connected to the image forming apparatus 201 as a device different from the image forming apparatus 201.

The image forming apparatus 201 includes, in the main body 201A, an image forming mechanism 201B, an intermediate transfer unit 201C, a secondary transfer unit 201D, a fixing device 201E, and cassette feeding units 230. The main body 201A includes a manual feeding unit 235.

The cassette feeding units 230 each feed recording materials S from a corresponding one of feeding cassettes 231 accommodating the recording materials S. The cassette feeding unit 230 includes a pickup roller 232 and a separation unit for separating recording materials S sent out from the pickup roller 232. The separation unit includes a feed roller 233 and a retard roller 234. The recording materials S are fed one by one from the feeding cassette 231 by the pickup roller 232 and the separation unit. In the at least one embodiment, description is given of a configuration in which a plurality of (in this example, four) cassette feeding units 230 are provided. However, any number of cassette feeding units 230 may be provided. The recording material S fed from the cassette feeding unit 230 is conveyed to registration rollers 240 via conveyance rollers 280 and 290.

The recording material S can be fed from a unit other than the cassette feeding unit 230, that is, from the manual feeding unit 235. The manual feeding unit 235 includes a tray 236 for receiving recording materials S manually placed by the user. Similar to the cassette feeding unit 230, the manual feeding unit 235 includes a pickup roller and a separation unit, and recording materials S are fed one by one from the tray 236. The recording material S fed from the manual feeding unit 235 is also conveyed to the registration rollers 240 via the conveyance rollers 280 and 290.

The image forming mechanism 201B is of a four-drum full-color type, and includes a laser scanner 210 and four image forming units 211. The four image forming units 211 form toner images of four colors, specifically, yellow (Y), magenta (M), cyan (C), and black (K). Each image forming unit 211 includes a photosensitive drum 212, a charging device 213, and a developing device 214. Toner cartridges 215 are arranged above the image forming units 211. The toner cartridges 215 replenish the respective developing devices 214 with toner.

The intermediate transfer unit 201C includes an intermediate transfer belt 216 wound around a drive roller 216a and a tension roller 216b. On an inner side of the intermediate transfer belt 216, there are provided four primary transfer rollers 219 which are in abutment against the intermediate transfer belt 216 at positions opposing the photosensitive drums 212. The intermediate transfer belt 216 is rotated in the direction of an arrow R3 by the drive roller 216a driven by a drive unit (not shown).

The secondary transfer unit 201D includes a secondary transfer roller 217 provided so as to sandwich the intermediate transfer belt 216 at a position opposing the drive roller 216a. The fixing device 201E is provided on a downstream side of the secondary transfer roller 217 in the conveyance direction of the recording material S, and includes a pressure roller 220a and a heating roller 220b. On a downstream side of the fixing device 201E in the conveyance direction of the recording material S, there are arranged first delivery rollers 225a, second delivery rollers 225b, and a duplex-printing reversing unit 201F. The duplex-printing reversing unit 201F includes reversing rollers 222 and a re-conveyance passage R. The reversing rollers 222 are rotatable in forward and reverse directions. The re-conveyance passage R allows the recording material S having an image formed on one side thereof to be conveyed to the image forming mechanism 201B.

The image forming apparatus 201 having the configuration as described above operates as follows. The image forming apparatus 201 acquires, together with an instruction to start a print job, image data from the image reading device 202 or from the external device 1000 and forms an image corresponding to the image data on the recording material S. A print job is a series of operations performed based on a print signal instructing an image to be formed on the recording material S, in which a conveyance process and an image forming process are executed, and after the image printing is complete, the recording material S is delivered to the placement portion 223. The image forming apparatus 201 acquires the instruction to start the print job from the operation unit 502 or the external device 1000.

The image forming mechanism 201B uses the charging device 213 to uniformly charge surfaces of the photosensitive drums 212 to an electric potential having a predetermined polarity. The laser scanner 210 irradiates the uniformly charged surfaces of the photosensitive drums 212 with corresponding laser beams modulated based on the image data. In this way, electrostatic latent images for corresponding colors (yellow, magenta, cyan, and black) are formed on the respective surfaces of the photosensitive drums 212.

The image forming mechanism 201B uses the developing devices 214 to develop the electrostatic latent images formed on the photosensitive drums 212. The electrostatic latent images are developed on the photosensitive drums 212 with toners of corresponding colors so that toner images of the corresponding colors are formed on the photosensitive drums 212. The toner images are sequentially transferred from the photosensitive drums 212 to the rotating intermediate transfer belt 216 in superimposition by the primary transfer rollers 219. In this way, a full-color toner image is formed on the intermediate transfer belt 216. The intermediate transfer belt 216 rotates to convey the toner image to the secondary transfer unit 201D.

Concurrently with such operation of forming a toner image, the recording materials S are conveyed one by one by the cassette feeding unit 230 or the manual feeding unit 235 to the registration rollers 240. The registration rollers 240 correct skew of the recording material S conveyed to the registration rollers 240. After the skew is corrected, the recording material S is conveyed by the registration rollers 240 to the secondary transfer unit 201D in synchronization with the timing at which the toner image borne on the intermediate transfer belt 216 is conveyed to the secondary transfer unit 201D. The secondary transfer unit 201D transfers the full-color toner image from the intermediate transfer belt 216 onto the recording material S with secondary transfer bias applied to the secondary transfer roller 217.

The recording material S having the toner image transferred thereto is conveyed to the fixing device 201E. The fixing device 201E sandwiches and conveys the recording material S with a roller nip portion defined by the pressure roller 220a and the heating roller 220b. The fixing device 201E heats the recording material S with the heating roller 220b at the time of sandwiching and conveying the recording material S, to thereby melt and mix the toners of respective colors on the recording material S. Further, the fixing device 201E presses the recording material S with the pressure roller 220a, to thereby fix the melted and mixed toners to the recording material S. At this time, the viscosity of the melted toner generates a sticking force to the heating roller 220b on the recording material S.

The recording material S having the image fixed thereto is delivered to the delivery space D by any one of the first delivery rollers 225a and the second delivery rollers 225b. The recording material S is placed on the placement portion 223 provided in a protruding manner on a bottom surface of the delivery space D. In a case where images are formed on both surfaces of the recording material S, the recording material S having an image fixed on one surface thereof is conveyed by the reversing rollers 222 to the re-conveyance passage R. The recording material S is conveyed again to the image forming mechanism 201B, and an image is formed on another surface of the reversed recording material S. The re-conveyance passage R allows the recording material S to be conveyed to the conveyance path between the conveyance roller 290 and the registration rollers 240.

In this way, in the image forming apparatus 201, the recording material S is conveyed along a conveyance path (vertical path) extending in the vertical direction. During image formation, the recording material S is conveyed from a lower side toward an upper side in the vertical direction from the registration rollers 240 to the fixing device 201E, with the upper side as the leading edge. When conveyed through the re-conveyance passage R, the recording material S is conveyed from the upper side toward the lower side in the vertical direction, with the lower side as the leading edge.

Operation of the image forming apparatus 201 is controlled by the main controller 101, which is the same as that illustrated in FIG. 2. In this case, the placement portion 124 of the printer 120 includes the cassette feeding units 230 and the manual feeding unit 235. The conveyance unit 123 includes various rollers such as the conveyance rollers 280 and 290 and the registration rollers 240. The fixing unit 122 includes the fixing device 201E. The image forming unit P includes the image forming unit 211.

The recording material S used for printing in the image forming apparatus 100 and 201 as described above may use, as described above, in addition to a sheet in which paper is used, a document folder formed in a bag shape by folding a sheet material of a plastic material. The document folder has, for example, at least one side open and the remaining sides (edges) closed among a plurality of sides (edges) overlapping by folding a sheet material of a plastic material. The open side (edge) is referred to as “open portion,” and the closed side (edge) is referred to as “fixed portion.” The fixed portion includes a folded portion formed by folding the plastic material, and a closed portion in which the side (edge) has been fixed by a welding method using heat or ultrasonic waves or by a bonding method using an adhesive, for example. Normally, two sides of the document folder are fixed and closed, and the remaining two sides are open.

In a case where a document folder is conveyed with the open portion as the leading edge side, a side of the document folder having an open portion that is not fixed may open during conveyance. This may reduce the conveyance speed of the document folder and cause conveyance failure such as jamming to occur. Therefore, in order to prevent image conveyance failure, the document folder is conveyed with the fixed portion as the leading edge side in the conveyance direction.

The image forming apparatus 100 and 201 both have conveyance paths for duplex printing (duplex-printing conveyance path 304, re-conveyance passage R). In a case where duplex printing is performed on a document folder, after an image is printed on a first surface (front surface) of the document folder, the document folder is reversed so that the printing surface becomes a second surface (back surface), and the document folder is conveyed to the conveyance path for duplex printing. In a case where printing is performed on the first surface, the document folder is conveyed with the fixed portion as the leading edge side in the conveyance direction, and thus conveyance failure is prevented. However, reversing the printing surface means that the document folder is conveyed along the conveyance path for duplex printing with an open portion as the leading edge side. As described above, in a case where the document folder is conveyed with an open portion as the leading edge side, conveyance failure occurs.

For this reason, in a case where duplex printing is performed on a document folder, after an image is printed on the first surface, the document folder is temporarily conveyed out from the image forming apparatus 100 or 201, the printing surface is reversed to the second surface, and then the document folder is again conveyed from a feeding unit. The document folder is conveyed with a fixed portion (for example, a folded portion) as the leading edge side, and thus in a case where printing is performed on the second surface, the orientation of the image is reversed by 180 degrees to that in a case where printing is performed on the first surface. Therefore, in a case where duplex printing is performed on a document folder, it is required to optimize the image signal in order to match the orientations of the images printed on the first surface and the second surface. However, it is difficult for the user to perform such optimization.

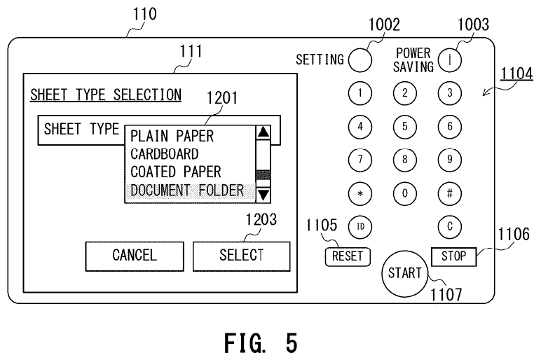

In the at least one embodiment, printing on a document folder is possible by selecting the type of sheet (recording material S) to be used for printing from a sheet type selection screen. FIG. 5 is an exemplary view of the sheet type selection screen. A selection screen 1201 is displayed on the display 111. On the selection screen 1201, the recording material S type can be freely selected, and document folder is provided as one of those freely-selectable sheet types.

In a case where the user selects and presses document folder from a pull-down menu on the selection screen 1201, the selected portion is displayed with its background being highlighted. In a case where the user subsequently presses a select button 1203, the selection of document folder as the sheet type is input to the main controller 101. The CPU 102 thereby sets the type of the recording material S to document folder.

In the at least one embodiment, the printing surface can be set by using a setting screen for a printing surface setting displayed on the display 111. As used herein, “printing surface setting” refers to setting, in addition to simplex printing and duplex printing, which surface of the document folder an image is to be printed on in simplex printing.

Setting information (image forming conditions) corresponding to document folder to be used at the time of image formation to prevent deterioration in conveyance performance and image quality is stored in the ROM 103 in advance. The CPU 102 acquires the setting information on document folder from the ROM 103, and uses the acquired setting information for control during image formation by the printer 120. As a result, deterioration in conveyance performance and image quality in a case where printing on a document folder is prevented.

### First Embodiment

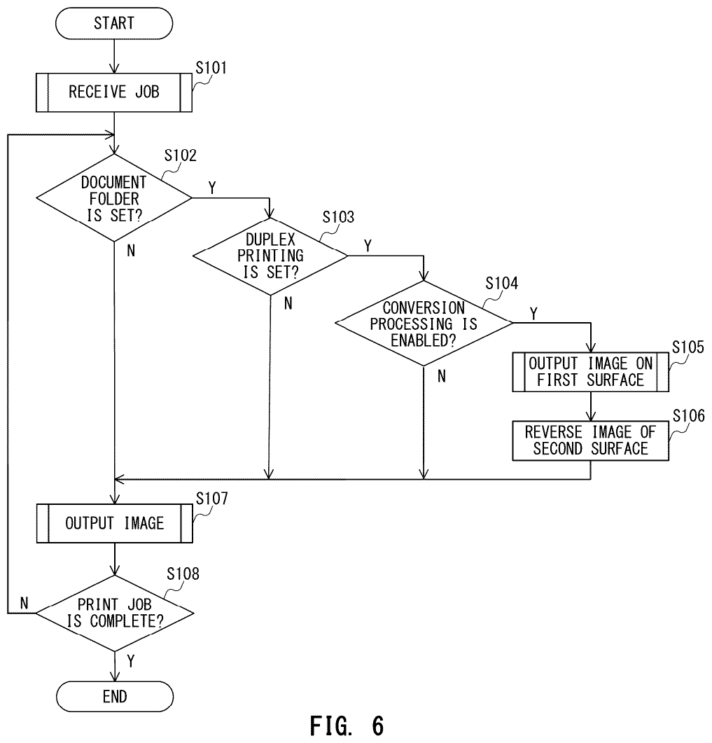

Description is now given of in a case where an image is printed on the document folder. The main controller 101 determines an image signal for forming an electrostatic latent image based on image data. FIG. 6 is a flowchart for illustrating image forming processing in a case where a print job is acquired. Here, description is given of processing executed in a case where the image forming apparatus 100 is used, but the same processing is possible in a case where the image forming apparatus 201 is used. In a first embodiment of the present disclosure, the user places a document folder (recording material S) in the placement portion 124 so that the fixed portion of the document folder becomes the leading edge of the recording material S in the conveyance direction. As described above, the fixed portion of the document folder is the folded portion and the closed portion.

The main controller 101 receives a print job including image data (Step S101). The print job is input from the external device 1000, for example. The main controller 101 determines, by using the image processor 105, whether or not document folder is set as the recording material S (Step S102). The sheet type setting is performed on the selection screen 1201 illustrated in FIG. 5 described above in a case where a print job is received. A case in which document folder is set is referred to as “first mode,” and a case in which a single sheet not having a fixed portion and an open portion other than a document folder is set is referred to as “second mode.” In a case where document folder is not set as the recording material S (Step S102: N), the main controller 101 uses the printer 120 to form the image on the recording material S without converting the image signal by the image processor 105 (Step S107).

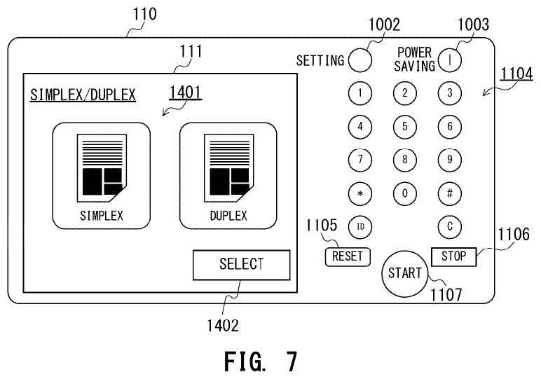

In a case where document folder is set as the recording material S (Step S102: Y), the main controller 101 determines whether or not duplex printing is set (Step S103). FIG. 7 is an exemplary view of a duplex printing selection screen displayed on the display 111. The duplex printing selection screen is a screen for setting the printing surface. The duplex printing selection screen includes a simplex/duplex selection screen 1401. In a case where the user selects any one of simplex printing and duplex printing from the simplex/duplex selection screen 1401 and presses a select button 1402, the main controller 101 sets the selected simplex printing or duplex printing.

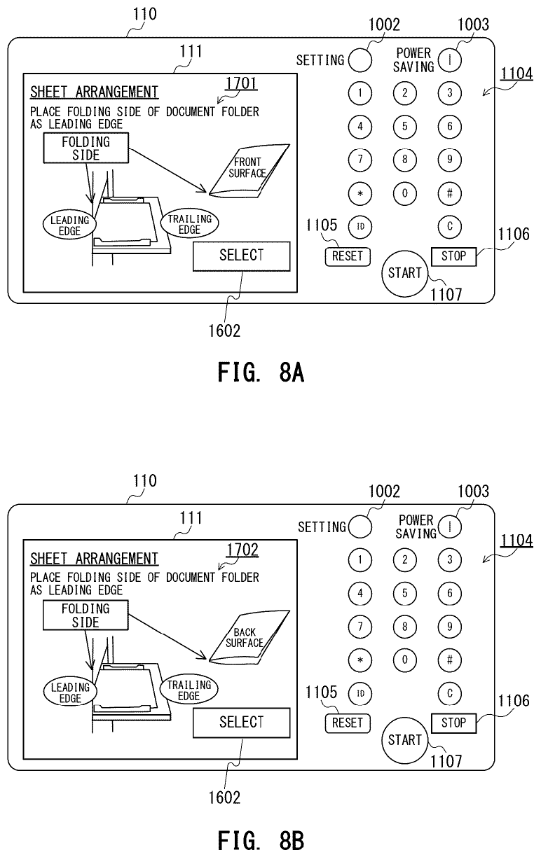

In a case where simplex printing is set (Step S103: N), the main controller 101 uses the printer 120 to form the image on the recording material S without converting the image signal by the image processor 105 (Step S107). During simplex printing, the main controller 101 may display, on the display 111, a guide screen which provides guidance regarding the orientation in a case where the recording material S is placed. Examples of the guide screen are illustrated in FIG. 8A and FIG. 8B. Guide screens 1701 and 1702 in FIG. 8A and FIG. 8B provide an instruction regarding the printing surface in addition to providing an instruction to place the folded portion of the document folder placed on the tray 17 as the leading edge side in the conveyance direction. In this case, the printing surface is the front surface.

The guide screen 1701 of FIG. 8A includes a message prompting the user to place the document folder so that the front surface is facing upward, with the folded portion of the document folder as the leading edge side in the conveyance direction. The image forming apparatus 100 prints an image while conveying the recording material S along the horizontal path extending in the horizontal direction. In this case, the image is printed on the front surface of the document folder by placing the document folder on the tray 17 with the front surface, which is the printing surface, facing upward.

The guide screen 1702 of FIG. 8B includes a message prompting the user to place the document folder so that the back surface is facing upward, with the folded portion of the document folder as the leading edge side in the conveyance direction. The image forming apparatus 201 prints an image while conveying the recording material S along the vertical path extending in the vertical direction. In this case, the image is printed on the front surface of the document folder by placing the document folder on the tray 236 with the front surface, which is the printing surface, facing downward.

In a case where duplex printing is set (Step S103: Y), the main controller 101 determines whether or not conversion processing of the image signal by the image processor 105 is enabled (Step S104). The determination as to whether or not conversion processing of the image signal by the image processor 105 is enabled is performed based on whether or not an image signal conversion enablement setting, which is described later, has been set to enable by the user. In a case where conversion processing of the image signal is set to be disabled (Step S104: N), the main controller 101 uses the printer 120 to form the image on the recording material S without converting the image signal by the image processor 105 (Step S107). In this case, the document folder is conveyed out from the image forming apparatus 100 after the image is printed on the first surface, placed in the placement portion 124 with the printing surface as the back surface, and an image is printed on the second surface. Conversion processing of the image signal is not performed in a case where the image is printed on the second surface.

In a case where conversion processing of the image signal is set to be enabled (Step S104: Y), the main controller 101 uses the printer 120 to form the image on the first surface, which is the front surface, of the recording material S without converting the image signal, and conveys the recording material S out from the image forming apparatus 100 (Step S105). The first surface is the surface on which an image is first printed on the recording material S during duplex printing. In this case, the image signal representing the image printed on the first surface is not subjected to conversion processing. The user reverses the printing surface of the recording material S which has an image printed on the first surface (turns the printing surface of the recording material S over to the second surface), and places the reversed recording material S in the placement portion 124. The main controller 101 converts the image signal representing the image to be printed on the second surface so that the image to be printed on the second surface, which is the back surface, is reversed by 180 degrees by the image processor 105 (Step S106). The second surface is the surface opposite to the first surface. The main controller 101 uses the printer 120 to form the image on the second surface of the recording material S based on the image signal converted by the image processor 105 (Step S107). The printing of the image on the first surface and the printing of the image on the second surface are both performed on the conveyed document folder with the folded portion being the leading edge in the conveyance direction.

During duplex printing, similarly to during simplex printing, the main controller 101 may display, on the display 111, a guide screen which provides guidance regarding the orientation in a case where the recording material S is placed. Examples of the guide screen are illustrated in FIG. 8A and FIG. 8B. This is the same guide screen as during simplex printing, but the meaning of the guide screen is different.

The guide screen 1701 of FIG. 8A includes a message prompting the user to place the document folder so that the front surface (first surface) is facing upward, with the folded portion of the document folder as the leading edge side in the conveyance direction and the closed portion as the far side. The guide screen 1701 of FIG. 8A is displayed during the processing step of Step S105. The guide screen 1702 of FIG. 8B includes a message prompting the user to place the document folder so that the back surface (second surface) is facing upward, with the folded portion of the document folder as the leading edge side in the conveyance direction and the closed portion as the near side. The guide screen 1702 of FIG. 8B is displayed during the processing step of Step S107 after the printing on the first surface is complete. As used herein, “near side” and “far side” are directions orthogonal to the conveyance direction, with the front side of the image forming apparatus 100 being the near side and the back side of the image forming apparatus 100 being the far side.

This instruction is a message used in a case where a document folder is placed on the tray 17 of the image forming apparatus 100. In a case where a document folder is placed on the tray 236 of the image forming apparatus 201, the message includes the opposite instruction for the front surface and the back surface. That is, in a case where the image forming apparatus 201 is used, the guide screen 1702 of FIG. 8B is displayed during the processing step of Step S105, and the guide screen 1701 of FIG. 8A is displayed during the processing step of Step S107.

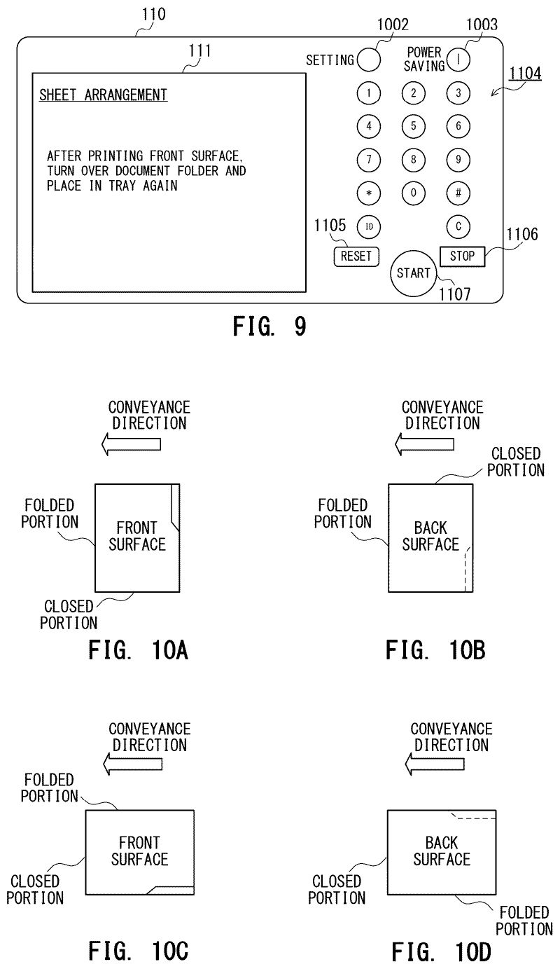

Further, in a case where duplex printing is performed, the main controller 101 may display an instruction screen illustrated in FIG. 9 on the display 111. This instruction screen is displayed on the display 111 at the start of the processing step of Step S105 or Step S107. In a case where the main controller 101 detects that the printing on the front surface (first surface) is complete and the document folder is placed on the tray 17, the main controller 101 deletes the instruction screen illustrated in FIG. 9 from the display 111 and performs printing on the back surface (second surface).

In a case where the image forming processing of Step S107 ends, the main controller 101 determines whether or not the print job is complete (Step S108). In a case where the print job is not complete (Step S108: N), the main controller 101 repeats the processing steps from Step S102 onwards. In a case where the print job is complete (Step S108: Y), the main controller 101 ends the image forming processing.

In the above-mentioned processing, an image can be printed on the document folder while creasing and conveyance failure of the document folder are prevented by conveying the folded portion of the recording material S as the leading edge. Further, in a case where document folder is selected as the type of the recording material S and duplex printing is selected, in order to match the orientation of the image to be printed on the second surface to the image to be printed on the first surface, the main controller 101 reverses the image of the second surface by 180 degrees by performing image processing on the image signal of the image. As a result, images can be printed on both surfaces of the document folder with matching orientations of the images on the front surface and back surface of the document folder.

In the first embodiment, the orientation of the image of the first surface is not converted, and the orientation of the image of the second surface is converted, but the reverse may be the case. That is, the processing may be performed such that the orientation of the image of the first surface is reversed by 180 degrees and the orientation of the image of the second surface is not converted. In the first embodiment, description is given of an example in which the recording material S is conveyed with the folded portion as the leading edge, but the recording material S may be conveyed with a closed portion as the leading edge.

The document folder has fixed portions (folded portion and closed portion) on two sides. For this reason, there are four ways (states) in which the document folder can be placed, depending on whether the folded portion (long side) or the closed portion (short side) is placed as the leading edge side in the conveyance direction, and which of the first surface (front surface) and the second surface (back surface) is placed facing upward. FIG. 10A, FIG. 10B, FIG. 10C, and FIG. 10D are explanatory diagrams of the placement states of a document folder. FIG. 10A shows an example in which a folded portion (long side) is placed as the leading edge side in the conveyance direction and the front surface is placed facing upward. FIG. 10B shows an example in which a folded portion (long side) is placed as the leading edge side in the conveyance direction and the back surface is placed facing upward. FIG. 10C shows an example in which a closed portion (short side) is placed as the leading edge side in the conveyance direction and the front surface is placed facing upward. FIG. 10D shows an example in which a closed portion (short side) is placed as the leading edge side in the conveyance direction and the back surface is placed facing upward.

In the case of duplex printing, the main controller 101 instructs the user to place the document folder as illustrated in FIG. 10A, and instructs the user to place the document folder as illustrated in FIG. 10B before starting printing on the second surface. Alternatively, after instructing the user to place the document folder as illustrated in FIG. 10C, the main controller 101 instructs the user to place the document folder as illustrated in FIG. 10D before starting printing on the second surface.

Description is now given regarding reversal of the orientation of the image in a case where a folded portion is placed so as to be on the leading edge side (FIG. 10A and FIG. 10B). In this case, in a case where the image is printed with a closed portion at the bottom (vertical direction), it is required to reverse the image, but in a case where the image is printed with a folded portion at the bottom (horizontal direction), it is not required to reverse the image. Description is now given regarding reversal of the orientation of the image in a case where a closed portion is placed so as to be on the leading edge side (FIG. 10C and FIG. 10D). In this case, in a case where the image is printed with a folded portion at the bottom (horizontal direction), it is required to reverse the image, but in a case where the image is printed with a closed portion at the bottom (vertical direction), it is not required to reverse the image. In this way, whether or not it is required to reverse (rotate) the image is determined based on the placement state of the document folder and the orientation (vertical direction, horizontal direction) of the image.

The above-mentioned image signal conversion enablement setting may be set based on the placement state of the document folder and the orientation of the image as described above. The orientation of the image is determined based on information included in the received print job.

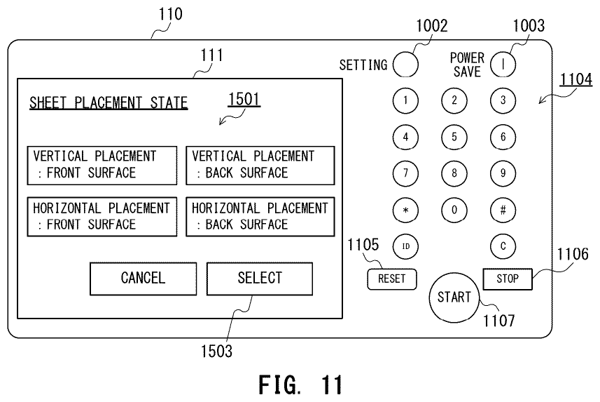

In place of the main controller 101 instructing the orientation during placement of the recording material S, the user may input the placement state at the time of placement of the recording material S to the main controller 101. In this case, the main controller 101 displays an input screen for the placement state of the recording material S on the display 111. FIG. 11 is an exemplary view of such an input screen.

From an input screen 1501 of FIG. 11, four placement states of the recording material S can be input: “vertical placement: front surface,” “vertical placement: back surface,” “horizontal placement: front surface,” and “horizontal placement: back surface.” The user can input the placement state of the recording material S during front surface printing and back surface printing by using the operation unit 110 to select the placement state of the recording material S during front surface printing and back surface printing from the input screen 1501 and pressing a select button 1503. The main controller 101 can determine whether or not it is required to reverse (rotate) the image based on the input placement state of the recording material S during front surface printing and back surface printing and the orientation (vertical direction, horizontal direction) of the image. Vertical placement is a state in which the recording material S is placed on the tray 17 so that the long sides of the recording material S are parallel to the conveyance direction. FIG. 10C and FIG. 10D are examples of vertical placement. Horizontal placement is a state in which the recording material S is placed on the tray 17 so that the short sides of the recording material S are parallel to the conveyance direction. FIG. 10A and FIG. 10B are examples of horizontal placement.

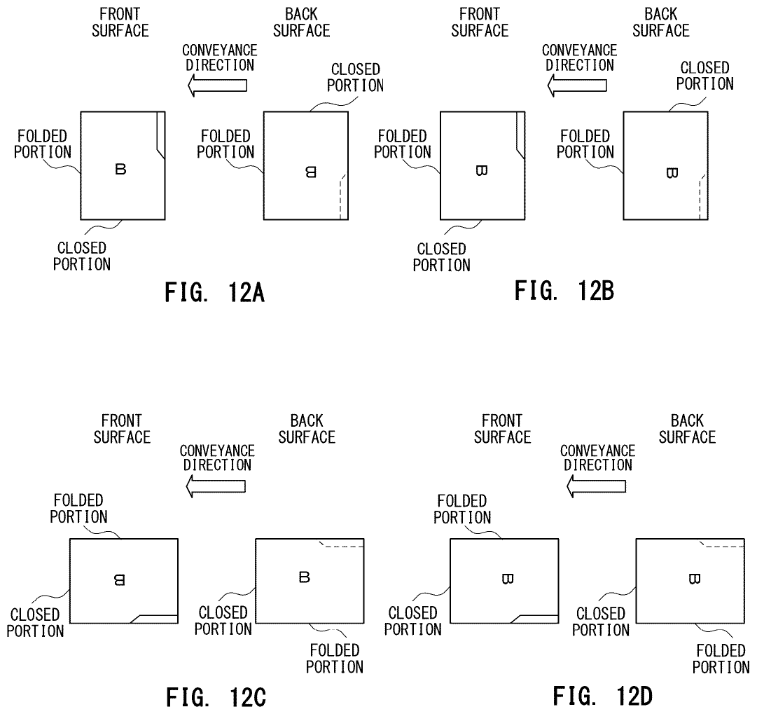

FIG. 12A, FIG. 12B, FIG. 12C, and FIG. 12D are explanatory diagrams of reversal of an image. FIG. 12A shows a case in which a folded portion is placed so as to be on the leading edge side (FIG. 10A and FIG. 10B) and an image is printed with a closed portion at the bottom (vertical direction). In this case, the images are reversed between the front surface and the back surface. FIG. 12B shows a case in which a folded portion is placed so as to be on the leading edge side (FIG. 10A and FIG. 10B) and an image is printed with the folded portion at the bottom (horizontal direction). In this case, the images are not reversed between the front surface and the back surface. FIG. 12C shows a case in which a closed portion is placed so as to be on the leading edge side (FIG. 10C and FIG. 10D) and an image is printed with a folded portion at the bottom (horizontal direction). In this case, the images are reversed between the front surface and the back surface. FIG. 12D shows a case in which a closed portion is placed so as to be on the leading edge side (FIG. 10C and FIG. 10D) and an image is printed with the closed portion at the bottom (vertical direction). In this case, the images are not reversed between the front surface and the back surface. In this way, the image formed on the front surface and the image formed on the back surface are formed so as to be reversed in the width direction orthogonal to the conveyance direction.

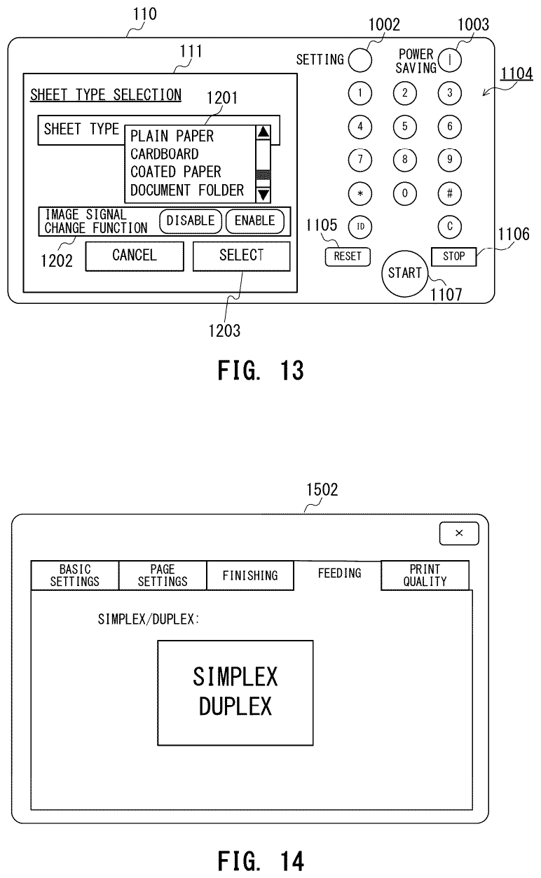

FIG. 13 is an exemplary view of a setting screen for setting whether or not conversion processing of the image signal by the image processor 105 is enabled. The image signal conversion enablement setting is performed based on an instruction from the user. For example, in a case where the user has prepared an image signal in advance in accordance with the orientation when placing the recording material S, the image processor 105 is not required to perform conversion processing of the image signal. Further, as described above, whether or not it is required to reverse (rotate) the image is determined depending on the placement state of the document folder and the orientation (vertical direction, horizontal direction) of the image. Therefore, it is preferred that the image signal conversion enablement setting be set individually for each print job. In a case where the user determines that image signal conversion processing cannot be performed normally due to an unexpected circumstance such as a malfunction in the operation of the image forming apparatus 100, the image signal conversion enablement setting is set to be disabled.

That is, the image signal conversion enablement setting is set to be enabled or disabled depending on the situation of each user and the printed product. As a result, it is possible to a provide a higher quality printed product. In the first embodiment, a selection screen for enabling/disabling image signal conversion processing is displayed on the display 111 of the operation unit 110. The user selects either enable or disable from this selection screen by using the operation unit 110.

In the processing step of Step S101 of FIG. 6, in addition to the sheet type selection screen 1201 illustrated in FIG. 5, an enable/disable setting screen 1202 for the image signal conversion enablement setting of FIG. 13 is displayed. In this case, the setting screen 1202 is displayed by pressing a button to start selection of the sheet type from a menu screen (not shown). The user can select whether to enable or disable the image signal conversion enablement setting from the setting screen 1202 by using the operation unit 110.

The user selects the sheet type from the selection screen 1201 by using the operation unit 110, selects whether to enable or disable the image signal conversion enablement setting from the setting screen 1202, and presses the select button 1203. As a result, the CPU 102 acquires the selection results of the sheet type and the image signal conversion enablement setting. The CPU 102 stores, based on those acquired selection results, information indicating the selected type (sheet type) of the recording material S and the selected image signal conversion enablement setting in the RAM 104. In this way, the main controller 101 sets the type of the recording material S and whether the image signal conversion processing is enabled/disabled. The main controller 101 performs image forming processing based on the information stored in the RAM 104.

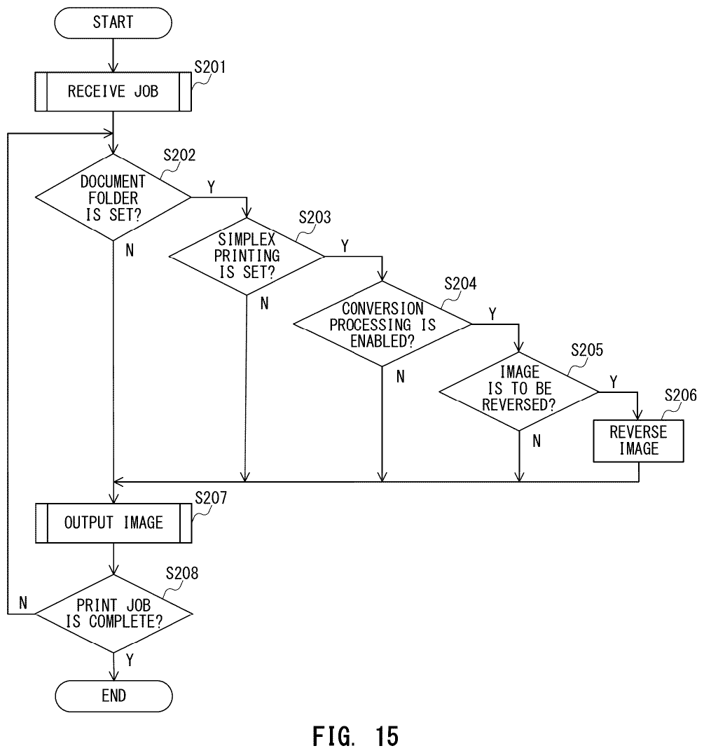

In the first embodiment, description is given of an example in which various settings related to printing are performed by the user operating the operation unit 110, but it is possible to perform the same processing even when the user operates the external device 1000. The external device 1000 is an information processing device which includes an input device and a display. The external device 1000 has the functions of the main controller 101, and a printer driver for using the image forming system 1X, for example, is installed in the external device 1000. On the display of the external device 1000, the printer driver displays, in accordance with the progress of the processing, screens for selecting the items to be set on each of the screens of FIG. 5, FIG. 7, and FIG. 13. Further, the guide screens of FIG. 8A and FIG. 8B and the instruction screen of FIG. 9 are displayed on the display of the external device 1000 in accordance with the progress of the processing. FIG. 14 is an exemplary view of a duplex printing selection screen displayed on a display 1502 of the external device 1000. This selection screen corresponds to the selection screen of FIG. 7. Even when the settings are performed by using the external device 1000, it is possible to print on the document folder as described above.

### Second Embodiment

Description is now given of when an image is printed on the document folder. The main controller 101 determines an image signal for forming an electrostatic latent image based on image data. FIG. 15 is a flowchart for illustrating image forming processing in a case where a print job is acquired. Here, description is given of processing in a case where the image forming apparatus 100 is used, but the same processing can be performed even in a case where the image forming apparatus 201 is used. In a second embodiment of the present disclosure, the user places a document folder (recording material S) in the placement portion 124 so that the fixed portion of the document folder becomes the leading edge of the recording material S in the conveyance direction.

Similarly to the processing steps of Step S101 and Step S102 of FIG. 6, the main controller 101 receives a print job including image data, and determines whether or not document folder is set as the recording material S based on the sheet type setting (Step S201, Step S202). In a case where document folder is not set as the recording material S (Step S202: N), the main controller 101 uses the printer 120 to form the image on the recording material S without converting the image signal by the image processor 105 (Step S207).

In a case where document folder is set as the recording material S (Step S202: Y), the main controller 101 determines whether or not simplex printing is set (Step S203). The simplex/duplex printing setting is performed by using the duplex printing selection screen illustrated in FIG. 7 or FIG. 14 described above. In a case where duplex printing is set (Step S203: N), the main controller 101 uses the printer 120 to form images on both surfaces of the recording material S without performing conversion processing of the image signal by the image processor 105 (Step S207).

In a case where simplex printing is set (Step S203: Y), similarly to the processing step of Step S104 of FIG. 6, the main controller 101 determines whether or not conversion processing of the image signal by the image processor 105 is enabled (Step S204). In a case where conversion processing of the image signal is set to be disabled (Step S204: N), the main controller 101 uses the printer 120 to form the image on the recording material S without converting the image signal by the image processor 105 (Step S207).

In a case where conversion processing of the image signal is set to be enabled (Step S204: Y), the main controller 101 determines whether or not to perform conversion processing (image reversal) of the image signal representing the image to be printed on one surface so as to reverse the image by 180 degrees (Step S205). In a case where conversion processing of the image signal is not performed (Step S205: N), the main controller 101 uses the printer 120 to form the image on the recording material S without converting the image signal by the image processor 105 (Step S207).

The determination as to whether or not to perform conversion processing of the image signal so as to reverse the image by 180 degrees is performed as follows. The ROM 103 stores in advance information on whether or not to reverse the image depending on which surface of the recording material S the image is to be printed on. For example, information indicating that, in a case in which a closed portion of a document folder is set as the near side, the image is not reversed in a case where the leading edge side is a folded portion, and the image is reversed in a case where the trailing edge side is a folded portion is stored in the ROM 103. The determination as to whether or not to reverse the image depending on which surface the image is to be printed on may be performed in the opposite manner.

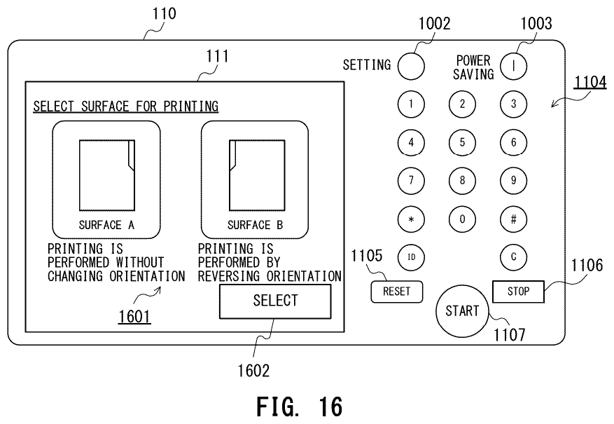

In a case where a job is input, the main controller 101 displays on the display 111 a selection screen 1601, which is illustrated in FIG. 16, for selecting which surface of the recording material S (document folder) the image is to be printed on. In FIG. 16, the surface on which the leading edge side becomes a folded portion in a case where a closed portion is set to the near side is “surface A,” and the surface on which the trailing edge side becomes a folded portion in a case where a closed portion is set to the near side is “surface B.”

The user selects any one of the surface A and the surface B from the selection screen 1601 by using the operation unit 110, and presses a select button 1602. As a result, the operation unit 110 transmits information on the selected surface to the main controller 101. The main controller 101 acquires information on the selected surface from the operation unit 110, and recognizes which of surface A and surface B has been selected. In FIG. 16, information indicating whether or not to convert the image signal of the image to be printed on any one of those surfaces may be displayed.

The main controller 101 performs the determination of Step S205 based on the selection performed on the selection screen 1601 and the information on whether or not to reverse the image depending on which surface of the recording material S the image is to be printed on stored in the ROM 103. In a case where the selected surface is the surface on which the image is to be reversed during printing, the main controller 101 determines that the image signal of the image to be printed on the selected surface is to be converted (Step S205: Y). In this case, the main controller 101 uses the image processor 105 to perform conversion processing of the image signal so that the image to be printed is reversed by 180 degrees (Step S206). After the conversion processing of the image signal by the image processor 105, the main controller 101 uses the printer 120 to form the image on the second surface of the recording material S (Step S207).

In a case where the image forming processing of Step S207 ends, the main controller 101 determines whether or not the print job is complete (Step S208). In a case where the print job is not complete (Step S208: N), the main controller 101 repeats the processing steps from Step S202 onwards. In a case where the print job is complete (Step S208: Y), the main controller 101 ends the image forming processing.

In the above-mentioned processing, an image can be printed on the document folder while creasing and conveyance failure of the document folder are prevented by conveying the folded portion of the recording material S as the leading edge. Further, images can be printed on both surfaces of the document folder with matching orientations of the images on the front surface and back surface of the document folder. In a case in which document folder is selected as the type of the recording material S and simplex printing is selected, in a case where conversion processing of the image signal is set to be enabled and the surface on which simplex printing is to be performed is the surface to be subjected to conversion processing, conversion processing of the image signal representing the image to be printed on the surface is performed.

Similarly to the first embodiment, in the second embodiment as well, the user can perform various settings relating to printing by operating the external device 1000. The printer driver displays a screen for setting the items to be set in the screens of FIG. 5, FIG. 14, and FIG. 16 on the display of the external device 1000 in accordance with the progress of the processing. Even when setting is performed by using the external device 1000, it is possible to print on the document folder.

In the second embodiment, conversion processing of the image signal is not performed in a case where duplex printing is set, but conversion processing of the image signal may be performed by the processing steps of Step S104 to Step S106 of FIG. 6 in a case where duplex printing is set. In the second embodiment, description is given of an example in which the recording material S is conveyed with a folded portion as the leading edge, but the recording material S may be conveyed with a closed portion as the leading edge. In this case, duplex printing can be performed by temporarily conveying the recording material S out from the image forming apparatus 100 or 201 after printing the image on the first surface, and placing the recording material S in the placement portion 124 when printing the image on the second surface.

As described in the first embodiment and the second embodiment, in the at least one embodiment, it is possible to reduce the possibility that the orientation in which the recording material is placed and the orientation in which the image is formed do not match.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-064419, filed Apr. 12, 2024, which is hereby incorporated by reference herein in its entirety.

What is claimed is:

1. An image forming apparatus comprising:
a selector configured to select a first mode for forming an image on a first recording material including a first side which is closed, a second side which is closed, a third side which is open, and a fourth side which is open;
a tray on which the first recording material is to be placed;
an image former configured to form an image on the first recording material conveyed from the tray;
a display; and
a controller configured to control, in a case where the first mode is selected by the selector, an orientation of an image to be formed in accordance with an orientation in which the first recording material is placed on the tray.

2. The image forming apparatus according to claim 1, further comprising an input unit configured to receive, as input, the orientation of a side and the orientation of a surface of the first recording material placed on the tray,
wherein the controller is configured to control the orientation of the image to be formed in accordance with the orientation of the side and the orientation of the surface of the first recording material acquired from the input unit.

3. The image forming apparatus according to claim 1,
wherein the first side is formed by folding a sheet material of the first recording material, and
wherein the second side is formed by closing sides which overlap in a case where the sheet material is folded.

4. The image forming apparatus according to claim 1, further comprising:
a conveyance path extending in a perpendicular direction orthogonal to a lower surface of the image forming apparatus; and
a conveyance unit configured to convey the first recording material from the tray to the image former by conveying the first recording material from a lower side of the conveyance path toward an upper side of the conveyance path,
wherein the display is configured to display, in a case where the first mode is selected by the selector, a message prompting a user to place the first recording material on the tray so that a printing surface of the first recording material faces downward.

5. The image forming apparatus according to claim 1, further comprising:
a conveyance path extending in a horizontal direction parallel to a lower surface of the image forming apparatus; and
a conveyance unit configured to convey the first recording material from the tray to the image former via the conveyance path,
wherein the display is configured to display, in a case where the first mode is selected by the selector, a message prompting a user to place the first recording material on the tray so that a printing surface of the first recording material faces upward.

6. The image forming apparatus according to claim 1, further comprising:
a duplex-printing conveyance path configured to reverse a recording material having an image printed on a first surface by the image former, and to convey the recording material to the image former again;
a placement portion configured to receive delivery of the recording material; and
a conveyance unit configured to convey the recording material,
wherein the conveyance unit is configured to deliver, in a case where the first mode is selected by the selector and duplex printing is set, after the image former prints an image on the first surface of the first recording material, the first recording material to the placement portion without guiding the first recording material along the duplex-printing conveyance path.

7. The image forming apparatus according to claim 6, wherein the display is configured to display a message prompting a user to place the first recording material delivered to the placement portion on the tray in a second orientation which is reversed from a first orientation used in a case where the first recording material is placed on the tray in order to print an image on the first surface.

8. An image forming apparatus comprising:
a selector configured to select a first mode for forming an image on a first recording material including a first side which is closed, a second side which is closed, a third side which is open, and a fourth side which is open;
a tray on which the first recording material is to be placed;
an image former configured to form an image on the first recording material conveyed from the tray;
a display; and
a controller configured to perform, in a case where the first mode is selected by the selector and duplex printing is performed, conversion processing of reversing an orientation of a first image to be formed on a first surface of the first recording material or an orientation of a second image to be formed on a second surface of the first recording material opposite to the first surface,
wherein the first image and the second image are formed to have reverse orientations in a width direction orthogonal to a conveyance direction on an image forming surface of a recording material.

9. The image forming apparatus according to claim 8, wherein the controller is configured to perform the conversion processing on the second image.

10. The image forming apparatus according to claim 9, wherein the controller is configured to cause the image former to form the first image on the first surface of the first recording material, and to then perform the conversion processing on the second image.

11. The image forming apparatus according to claim 10, wherein the controller is configured to cause the image former to form the second image subjected to the conversion processing on the second surface of the recording material.

12. The image forming apparatus according to claim 8, wherein the controller is configured to perform the conversion processing on the first image.

13. The image forming apparatus according to claim 12, wherein the controller is configured to perform the conversion processing on the first image, and to then cause the image former to form the first image subjected to the conversion processing on the first surface of the recording material.

14. The image forming apparatus according to claim 9, wherein the controller is configured to display, on the display, a setting screen for setting whether to perform the conversion processing of an image, and to avoid performing the conversion processing in a case where it is selected from the setting screen to avoid performing the conversion processing.

15. The image forming apparatus according to claim 9, further comprising a memory configured to store information on whether to perform the conversion processing depending on which surface of the recording material an image is to be printed on,
wherein the controller is configured to determine, in a case where the first mode is selected by the selector and simplex printing is selected, based on the information stored in the memory, whether to perform the conversion processing on the image to be formed on the surface selected to have an image formed thereon by simplex printing.

16. The image forming apparatus according to claim 15, wherein the controller is configured to perform the conversion processing in a case where the surface selected to have an image printed thereon by simplex printing is the surface to be subjected to the conversion processing in a case where printing is performed based on the information.

17. The image forming apparatus according to claim 16, wherein the controller is configured to display, on the display, a setting screen for setting whether to perform the conversion processing of an image, and to perform, in a case where it is selected from the setting screen to perform the conversion processing, the conversion processing in a case where the surface selected to have an image printed thereon by simplex printing is the surface to be subjected to the conversion processing in a case where printing is performed based on the information.

18. The image forming apparatus according to claim 1, wherein the first recording material is a document folder formed into a bag shape by folding a plastic sheet material.

19. The image forming apparatus according to claim 8, wherein the first recording material is a document folder formed into a bag shape by folding a plastic sheet material.

20. The image forming apparatus according to claim 18, further comprising a conveyance unit configured to convey a recording material,
wherein the image former is configured to form an image on the recording material conveyed by the conveyance unit, and
wherein the conveyance unit is configured to convey the document folder with a folded portion of the document folder as a leading edge in a conveyance direction.

21. The image forming apparatus according to claim 19, further comprising a conveyance unit configured to convey the recording material,
wherein the image former is configured to form an image on the recording material conveyed by the conveyance unit, and
wherein the conveyance unit is configured to convey the document folder with a folded portion of the document folder as a leading edge in the conveyance direction.

22. An information processing device which is communicably connected to an image forming apparatus including: a tray on which a first recording material is to be placed, the first recording material including a first side which is closed, a second side which is closed, a third side which is open, and a fourth side which is open; and an image former configured to form an image on the first recording material conveyed from the tray, the information processing device comprising:
a selector configured to select a first mode for forming an image on the first recording material;
a display; and
a controller configured to control, in a case where the first mode is selected by the selector, an orientation of an image to be formed in accordance with an orientation in which the first recording material is placed on the tray.

23. An information processing device which is communicably connected to an image forming apparatus including: a tray on which a first recording material is to be placed, the first recording material including a first side which is closed, a second side which is closed, a third side which is open, and a fourth side which is open; and an image former configured to form an image on the first recording material conveyed from the tray, the information processing device comprising:
a selector configured to select a first mode for forming an image on the first recording material;
a display; and
a controller configured to perform, in a case where the first mode is selected by the selector and duplex printing is performed, conversion processing of reversing an orientation of a first image to be formed on a first surface of the first recording material or an orientation of a second image to be formed on a second surface of the first recording material opposite to the first surface in a width direction orthogonal to a conveyance direction on an image forming surface of a recording material.
